(19) United States
(12) Patent Application Publication
(10) Pub. No.: US 2006/0156890 A1
(43) Pub. Date: Jul. 20, 2006

(54) Punch with a head having two metal carbide layers that differ in hardness and coefficient of expansion

(75) Inventor: Ching-Kwang Lee, Pingtung City (TW)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Major Industries Ltd.

(21) Appl. No.: 11/372,815

(22) Filed: Mar. 10, 2006

Related U.S. Application Data
(63) Continuation-in-part of application No. 10/790,308, filed on Mar. 1, 2004, now abandoned.

(51) Int. Cl. B26D 1/00; C11D 17/00

(52) U.S. Cl. 83/651; 83/697

(57) ABSTRACT

A punch includes a punch body and a punch head. The punch head includes a first layer of tungsten carbide brazed to the punch body, a second layer of tungsten carbide brazed to the first layer opposite to the punch body, and a brazing metal layer formed between the first and second layers. The first layer has a hardness lower than that of the second layer, and has a coefficient of expansion greater than that of the second layer and smaller than that of the punch body.

### CROSS-REFERENCE TO RELATED APPLICATION

This application is a continuation-in-part of U.S. patent application Ser. No. 10/790,308, filed on Mar. 1, 2004,

### BACKGROUND OF THE INVENTION

1. Field of the Invention

The invention relates to a punch, more particularly to a punch which includes a punch head having two metal carbide layers that differ in hardness and coefficient of expansion.

2. Description of the Related Art

A conventional solid carbide punch is generally made from tungsten carbide, which possesses excellent hardness and wear resistance. However, such a solid carbide punch is very easy to break from a punch shank during a punching operation due to low toughness of the punch.

Referring to FIG. 1, another type of punch 1 has been proposed to overcome the aforesaid drawback. The punch 1 includes a metal rod portion 12 and a tungsten carbide portion 11 brazed onto the metal rod portion 12. However, the punch 1 also tends to break at the interface between the metal rod portion 12 and the tungsten carbide portion 11 during a punching operation due to brazing stress in the aforesaid interface and due to a relatively large difference between the coefficients of expansion of the metal rod portion 12 and the tungsten carbide portion 11 at high temperatures, which are usually present during the punching operation.

A sandwich-type punch has been proposed to overcome this drawback. The sandwich-type punch is modified from the previous punch 1 by including a relatively soft metal portion sandwiched between and brazed to the metal rod portion and the tungsten carbide portion. However, the soft metal portion of the punch tends to deform or to break after a period of use.

Referring to FIG. 2, U.S. Pat. No. 2,888,247 disclosed a rock drill cutting insert 2, which is built up of two or more layers of tungsten carbide having different wear resistance and toughness. The rock drill cutting insert 2 is a sintered unit. Although how the sintered unit was made is not described in the patent, as well known in the art, a multi-layered sintered unit may be produced by stacking layers of green compacts (e.g., green compacts having different compositions of tungsten carbide powders which produce different hardness) or sintered bodies (e.g., sintered bodies having different hardness of tungsten carbides) and by sintering the same together. Since the sintering process is conducted usually at a relatively high temperature ranging from about 1350° C. to about 1370° C., the bonding metal (e.g., cobalt) for the tungsten carbide contained in the layers can diffuse from one layer to another, resulting in changes in the ratio of the bonding metal to the tungsten carbide in each layer. Therefore, it is difficult to control the composition and the hardness of each layer of the sintered unit. Moreover, because of the relatively high sintering temperature, the sintered unit will inevitably deform or buckle due to the different thermal expansion coefficients of the layers in the sintered unit.

### SUMMARY OF THE INVENTION

The object of the present invention is to provide a punch which includes a punch head having excellent hardness while maintaining relatively high toughness.

A punch according to this invention includes a punch body and a punch head. The punch head includes a first layer of tungsten carbide brazed to the punch body, a second layer of tungsten carbide brazed to the first layer opposite to the punch body, and a brazing metal layer formed between the first and second layers. The first layer has a hardness lower than that of the second layer, and has a coefficient of expansion greater than that of the second layer.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional punch;

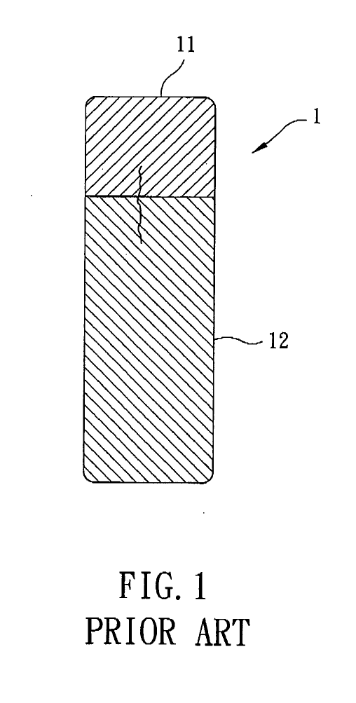

FIG. 2 is a partly sectional view of a rock drill cutting insert according to U.S. Pat. No. 2,888,247; and

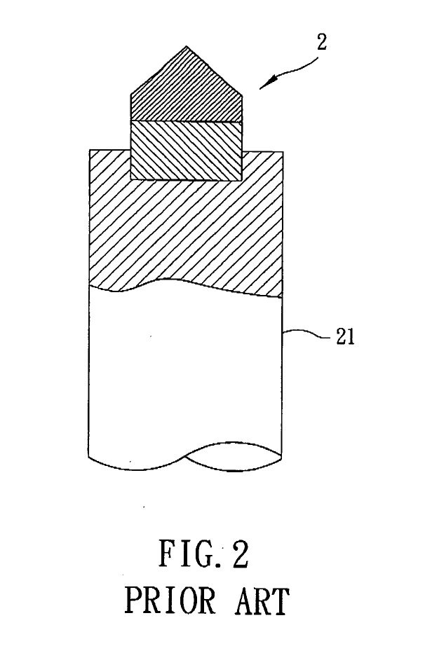

FIG. 3 is a partly sectional view of the preferred embodiment of a punch according to this invention.

### DETAILED DESCRIPTION OF THE PREFERRED EMBODIMENT

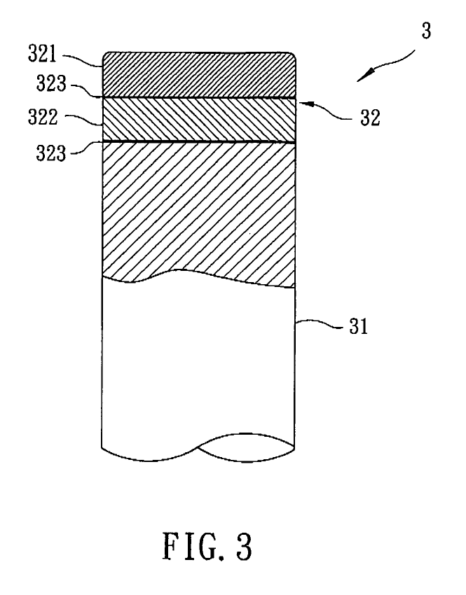

Referring to FIG. 3, the preferred embodiment of a punch 3 according to this invention is shown to include a punch body 31 and a punch head 32. The punch head 32 includes a first layer 322 of tungsten carbide brazed to the punch body 31, and a second layer 321 of tungsten carbide brazed to the first layer 322 opposite to the punch body 31. The first layer 322 is joined to the punch body 31 by brazing or other suitable joining or bonding method. Each of the first and second layers 322,321 contains cobalt as a bonding metal to bond grains of the tungsten carbide. The first layer 322 has a hardness lower than that of the second layer 321, and has a coefficient of expansion greater than that of the second layer 321.

The first and second layers 322, 321 are provided with different hardness by varying the ratio of the amount of the cobalt to the amount of the tungsten carbide, or by varying the grain sizes of the tungsten carbide contained therein. Specifically, the first layer 322 has a hardness lower than that of the second layer 321, which can be achieved by making the ratio of the amount of the cobalt to the amount of the tungsten carbide in the first layer 322 larger than that in the second layer 321 without changing the grain size of the tungsten carbide, by making the grain size of the tungsten carbide contained in the first layer 322 greater than that of the tungsten carbide contained in the second layer 321 without changing the ratio, or by varying both of the ratio and the grain size.

As described above, the first layer 322 has a coefficient of expansion greater than that of the second layer 321 and smaller than that of the punch body 31. In other words, the difference between the coefficient of expansion of the first layer 322 and that of the punch body 31 is smaller than the difference between the coefficient of expansion of the second layer 321 and that of the punch body 31. Therefore, the risk of cracking at the brazing interface between the punch body 31 and the punch head 32 can be reduced, and the deformation problem of the prior art can be avoided as well. Furthermore, since the first layer 322 is provided as a medium between the punch body 31 and the second layer 321, the stress produced upon brazing can be reduced thereby, which in turn reduces the risk of cracking or breaking.

According to the present invention, the first and second layers 322,321 are joined together by brazing, thereby forming a brazing metal layer 323 therebetween. The brazing metal layer 323 may have a thickness of about 0.01 to 0.05 mm, and may be formed from a filler metal having a brazing temperature in a range from 925 to 1095° C., preferably, in a range from 960 to 980° C. One example of the filler metal is a Ni-based filler metal, for example, BNi-6 designated by AWS (American Welding Society).

In the present invention, brazing is done by providing a filler metal between the first and second layers 322,321 and by heating the same at a temperature (e.g. 960° C.) relatively lower than a sintering temperature. When the filler metal melts, the brazing metal layer 323 is formed between the first and second layers 322, 321. Diffusion of the filler metal into the first and second layers 322, 321 occurs only at a very small depth, i.e., about 0.10 mm. Furthermore, because of the relatively low brazing temperature, the bonding metal in the first and second layers 322,321 does not diffuse from one layer to the other. Therefore, a predetermined ratio of the bonding metal to the tungsten carbide can be maintained, and a desired hardness can be achieved in each layer.

The thin brazing metal layer 323 formed between the first and second layers 322, 321 provides the punch head 32 with high toughness and high strength, and can absorb stress produced upon brazing due to the different thermal expansion coefficients of the first and second layers 322,321. Therefore, a risk that the punch head 32 will deform and buckle can be reduced.

The following Examples 1 to 4 illustrate variations in hardness with changes in weight percentage of cobalt. The results are listed in Table 1. As shown in Table 1, the greater the amount of cobalt contained in the layer, the lower will be the hardness of the layer of the punch head 32.

TABLE 1

| | Cobalt wt % | Tungsten wt % | Hardness, HAR |
|---|---|---|---|
| Example 1 | 5 | 95 | 90 |
| Example 2 | 10 | 90 | 89 |
| Example 3 | 15 | 85 | 85 |
| Example 4 | 20 | 80 | 84 |

The following Examples 5 to 8 illustrate variations in hardness with changes in grain size of tungsten carbide. The results are listed in Table 2. As shown in Table 2, the smaller the grain size of tungsten carbide contained in the layer, the greater will be the hardness of the layer of the punch head 32.

TABLE 2

| | | Grain size of | |
|---|---|---|---|
| | Cobalt wt % | tungsten carbide, Mm | Hardness, HAR |
| Example 5 | 10 | 0.6 | 89 |
| Example 6 | 10 | 2.0 | 86 |
| Example 7 | 5 | 0.8 | 90 |
| Example 8 | 5 | 1.0 | 89 |

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A punch comprising:
a punch body; and
a punch head including a first layer of tungsten carbide brazed to said punch body, a second layer of tungsten carbide brazed to said first layer opposite to said punch body, and a brazing metal layer formed between said first and second layers,
wherein said first layer has a hardness lower than that of said second layer, and has a coefficient of expansion greater than that of said second layer.

2. The punch as claimed in claim 1, wherein said brazing metal layer has a thickness of about 0.01 to 0.05 mm.

3. The punch as claimed in claim 1, wherein said brazing metal layer has a brazing temperature ranging from 925 to 1095° C.

4. The punch as claimed in claim 1, wherein said brazing metal layer is further formed between said punch body and said first layer.

5. The punch as claimed in claim 1, wherein each of said first and second layers of said punch head includes a bonding metal, the amount of said bonding metal is more in said first layer than in said second layer.

6. The punch as claimed in claim 1, wherein the tungsten carbide contained in said first layer has a grain size greater than that of the tungsten carbide contained in said second layer.
